(19) United States
(12) Patent Application Publication
(10) Pub. No.: US 2025/0225784 A1
(43) Pub. Date: Jul. 10, 2025

(54) MONITORING HYDROCARBON EQUIPMENT USING ENHANCED SATELLITE IMAGES

(71) Applicant: Saudi Arabian Oil Company, Dhahran (SA)

(72) Inventors: Ali Alshehri, Thuwal (SA); Hamad Alsaiari, Al Khobar (SA); Sarah A. Aqeel, Dhahran (SA)

(21) Appl. No.: 18/404,459

(22) Filed: Jan. 4, 2024

(51) Int. Cl. G06V 20/13; B60W 60/00; G06V 20/10

(52) U.S. Cl. CPC G06V 20/13; B60W 60/001; G06V 20/176

(57) ABSTRACT

A method, system, and non-transitory computer readable media for analyzing and correcting satellite images representing an environment that includes hydrocarbon equipment. The analysis includes receiving satellite input images of the environment captured at different time instances and receiving environmental data representing a state of the environment. The analysis includes determining a feature for extraction and applying, based on the feature and the state of the environment, image processing functions to adjust pixels of the satellite input images. At least one machine learning model is configured to analyze feature data that is extracted from two or more different time instances of the satellite input images. The analysis includes identifying one or more objects from the hydrocarbon equipment in the environment and generating a prediction for an object among the one or more objects in the environment.

### TECHNICAL FIELD

This specification relates generally to image processing of satellite images and more particular to satellite remote sensing coupled with artificial intelligence for oil and gas applications.

### BACKGROUND

Remote sensing includes the collection of images and sensor measurements of environments on the Earth's surface through sensors located remotely from the environments. The proliferation and increased accessibility of high-resolution remote sensing data provides detecting and monitoring of these environments by measuring reflected and emitted radiation from the environment. These remote sensors periodically capture images of an environment and can provide useful information about objects in the environment from a substantially far distance from the surface of the Earth. thousands of miles above the surface of the Earth.

Although remote sensing data is widely available, some types of data such as satellite images can include a number of defects that limit utility of these images for particular applications such as object detection. Weather patterns, environmental data, and on-board sensor errors can degrade image quality of satellite images, thereby affecting image processing outputs from the satellite images.

### SUMMARY

This specification describes systems and methods for monitoring an environment with one or more remote sensors and recommending corrective actions based on the monitoring. The environment can include a platform with equipment for the extraction of hydrocarbons, as well as aircraft that surveil the platform. A data processing system can enhance input images representing the well platform and its environment and generate predictions for one or more objects in the environment. A prediction can indicate one or both of an operational status for equipment of the platform or a trajectory for an aircraft in the environment.

The systems and methods include executing machine learning models trained to identify environmental patterns from the environmental data and an impact of the environmental patterns on the input images that affect image quality. The data processing system compensates for the adverse effects of the environmental patterns in the input images by applying one or more image processing algorithms to pixel values and attributes of the input images. The data processing system generates, based on the image processing, one or more adjusted images that improve the detectability and features of objects in the adjusted images. A prediction engine is configured to generate predictions for one or more objects represented by pixels in the adjusted image. The predictions can each indicate a characteristic, such as the operational status, for the one or more objects (such as equipment).

The data processing system uses the machine-learning models, image processing algorithms, and the prediction engine to improve the monitoring and surveillance of equipment assets of the platform in the environment. Specifically, the data processing system can recommend a corrective action based on the predicted characteristics of the enhanced images. The data processing system enhances resolution of the satellite images by identifying defects and removing noise. Enhancements and corrections in the satellite images results in accuracy improvements for predictions generated from the enhanced image. For example, the data processing system generates predictions of objects in the environment such as autonomous vehicles that monitor the environment. The predictions can include a trajectory, predicted launch points and their associated likelihoods, predicted landing points and their associated likelihoods, or some combination thereof, for an autonomous vehicle in the environment. The predictions can be provided to a device configured for retrieval of autonomous vehicles in the environment. As another example, the prediction can include a label indicating a health status of objects in the environment such as hydrocarbon equipment. The prediction for the health status of a piece of hydrocarbon equipment can be provided to a device configure to maintain or control the hydrocarbon equipment. The device can control operation of the hydrocarbon equipment based on the prediction from the data processing system. The device can prevent failure or further degradation of the hydrocarbon equipment by adjusting or controlling the operation of the hydrocarbon equipment.

Accurate monitoring and surveillance of equipment assets (e.g., pipes, valves, drills) of the platform can be difficult. The platform can be located in a remote area (e.g., open water in the ocean) that is difficult to access. Remote sensors are configured to capture images and measurements of the environment. However, the platform can experience turbulent conditions, atypical weather patterns, climate patterns, and other degradation sources that can affect image quality of images captured by remote sensors. As an example, satellite images captured by a satellite monitoring the environment can include blurs and distortions in the pixel values, and thus affects the feature data processed by the prediction engine that generates a prediction for the assets.

Some approaches for asset monitoring include use of unmanned aircraft equipped with camera systems to capture images of the environment. However, utilization of unmanned aircraft for asset monitoring can pose multiple limitations, such as operable travel times and range of the drone due to battery size and capacity. A relatively small size of the unmanned aircraft limits the type and size of camera devices that can be onboard the aircraft and thus limits the camera resolution and cadence of measurements. As another example, stability of the camera sensors can be difficult to maintain in turbulent conditions of the environment, resulting in unsmooth trajectories. Thus, these aircraft can often become damaged and recoverable during monitoring of the environment.

To overcome these issues, the approaches described in this specification provide systems and methods that provide the following advantages. A data processing system is configured for near-real time of monitoring, surveillance, and predictions related to the objects in the environment using high-resolution images and error-compensated satellite images. The data processing system is configured to generate enhanced images by applying image processing algorithms to correct for radiometric, geometric, and other types of defects in the pixel data of the satellite images. The data processing system provides improvements in the resolution of the satellite images by removing noise and correcting for defects resulting from environmental factors of the area captured in the satellite images. The image processing algorithms improve feature data in the spatial and/or frequency domains by correcting for image defects through machine learning models trained on satellite images and environmental data. The machine learning model can be trained using different sources of satellite images (e.g., simulated images, images from different agencies) and different sources of environmental data for the region of the Earth's surface being imaged by the satellite images.

The data processing system can generate predictions of objects in the environment by processing feature data from the enhanced images. The predictions generated from the enhanced images provide improvements to the classification and detection of faults for equipment of a platform in the environment. For example, the data processing system can classify a type of hydrocarbon equipment or autonomous vehicle for the environment. The data processing system generates a prediction by analyzing the object over multiple image frames at different time instances, each image frame being enhanced by the image processing algorithms.

The predictions can provide an indication of structural integrity for the assets in the environment that otherwise would not be detected. In some cases, the predictions can provide an earlier indication of a fault in the equipment before the fault is detected by other means, such as equipment failure, manual inspection, and so forth. The earlier detection of faults can improve user safety and reduce maintenance expense. The continuous image-processing techniques improve accuracy and quality of feature data from the pixels of the adjusted images because the improvements to image resolution account for environmental (e.g., weather, climate, atmospheric) effects for the imaged region. The data processing system can extract features such as shape, texture, color, edges, surrounding of sub features and so forth. The data processing system can adjust the images based on the extracted features to account for defects from the environmental data.

The disclosed technology enables preemptive replacement or repair of equipment before faults result in catastrophic failure, such as oil spills, gas leakages, and fires. The predictions can help prevent spills of extracted resources, like oil and natural gas, into the surroundings of the platform, such as the ocean or local ecosystems. The data processing system and processes herein can improve an accuracy and a utility of satellite images by incorporating other types of environmental data such as air quality, weather data, climate data. By correcting the effects of the environmental data in the satellite images, the accuracy of the resulting prediction from the enhanced satellite images can also be improved, e.g., for predicting operational status of equipment and position of aircraft in the environment. Further, by estimating the trajectory of aircraft configured to monitor the environment, launch points, and state information (e.g., position, velocity, and acceleration) can be identified. Thus, the estimated position can provide that lost aircraft can be found.

Embodiments of these systems and methods can include one or more of the following features to enable one or more of the foregoing advantages.

In an aspect, a method for analyzing and correcting satellite images representing an environment that includes hydrocarbon equipment. The method includes receiving, by a computer system, satellite input images representing the environment captured by one or more satellites at different time instances, and receiving, by a communication network coupled to the computer system, environmental data that represents a state of the environment. The method includes determining at least one feature for extracting from the satellite input images, and applying, based on determining the at least one feature and the state of the environment determined from the environmental data, one or more image processing functions to adjust pixels of the satellite input images for extraction of the at least one feature. The method includes analyzing, by at least one machine learning model, feature data including the at least one feature that is extracted from two or more different time instances of the satellite input images. The method includes identifying, based on the analyzed feature data and by the at least one machine learning model, one or more objects from the hydrocarbon equipment in the environment, the identifying being based on the two or more different time instances of the satellite input images. The method includes generating, based on the analyzed feature data and the identified one or more objects, a prediction for an object among the one or more objects in the environment.

In some implementations, the at least one machine learning model is trained to generate predictions of objects from the hydrocarbon equipment in the environment. Training the at least one machine learning model includes generating, by a simulation configured to generate synthetic satellite images of the environment and using the environmental data, a training example including the generated synthetic satellite images. Training the at least one machine learning model includes applying, by the at least one machine learning, the one or more image processing functions to the training example to generate a training set of adjusted images. An adjusted image from the training set of adjusted images includes pixels adjusted by the one or more image processing functions. The training includes comparing the training set of adjusted images from the generated synthetic satellite images of the environment to a set of adjusted images generated from the satellite input images of the environment, and updating, based on a comparison of the training set of adjusted images and the set of adjusted images, one or more parameters of the at least one machine learning model.

In some implementations, the method includes determining, based on the environmental data, one or more environmental effects from the environment that affect a quality of the satellite input images, and removing, the one or more environmental effects from the satellite input images.

In some implementations, the object is an autonomous vehicle and the prediction for the object includes at least one of (i) a trajectory, or (ii) a location, for the autonomous vehicle. In some implementations, the method includes providing the prediction that includes at least one of (i) the trajectory, or (ii) the location at least one of (i) a system configured to retrieve autonomous vehicles, or (ii) a computing device configured to monitor retrieval of autonomous vehicles, in the environment.

In some implementations, the object is a piece of the hydrocarbon equipment, and the prediction includes a status indicator for the piece of the hydrocarbon equipment, the status indicator representing a health status of the piece of the hydrocarbon equipment. In some implementations, the method includes providing the prediction including the status indicator for the piece of the hydrocarbon equipment in the environment to a system configured to monitor the environment.

In some implementations, identifying the one or more objects in the environment includes determining a difference in (i) size and structures, or (ii) positions, of pixels from the analyzed feature data for the satellite input images.

In some implementations, analyzing the feature data by the at least one machine learning model includes generating, by a convolutional neural network (CNN) of the at least one machine learning model, subsets of the satellite input images. A subset of the satellite input images share a plurality of topological features in the feature data determined by the convolutional neural network. Analyzing the feature data includes determining, by one or more recurrent neural networks (RNN) of the at least one machine learning model, one or more patterns over the different time instances from the feature data for the subsets of the satellite input images. The analysis of the feature data also includes identifying one or more objects in the environment based on the one or more patterns, and generating the prediction based on the one or more patterns for the one or more objects in the environment from the feature data.

In some implementations, the method includes downsampling the satellite input images at a first resolution to a plurality of image datasets at a plurality of resolutions. Each resolution in the plurality of resolutions is lower than the first resolution. The method includes generating a first set of predictions for the plurality of image datasets and combining, by a conditional generative adversarial network of the at least one machine learning model, the first set of predictions to a second set of predictions generated from the input images at the first resolution. The second set of predictions are generated at second resolution greater than the first resolution.

In some implementations, the one or more image processing functions includes at least one of (i) denoising, (ii) filtering, (iii) contrast adjustment, (iv) position alignment, (v) downsampling, (vi) up-sampling, (vii) edge enhancement, of the pixels in the satellite input images.

In some implementations, the environmental data includes at least one of (i) infrared data, (ii) simulation data, (iii) weather conditions, (iv) ground truth measurements, (v) historical data, (vi) geological data, or (vii) climate data, of the environment.

A system for analyzing and correcting satellite images representing an environment that includes hydrocarbon equipment includes at least one processor and a memory storing instructions that, when executed by the at least one processor, cause the at least one processor to perform operations. The operations include receiving, by a computer system, satellite input images representing the environment captured by one or more satellites at different time instances, and receiving, by a communication network coupled to the computer system, environmental data that represents a state of the environment. The operations include determining at least one feature for extracting from the satellite input images and applying, based on determining the at least one feature and the state of the environment determined from the environmental data, one or more image processing functions to adjust pixels of the satellite input images for extraction of the at least one feature. The operations include analyzing, by at least one machine learning model, feature data including the at least one feature that is extracted from two or more different time instances of the satellite input images, and identifying, based on the analyzed feature data and by the at least one machine learning model, one or more objects from the hydrocarbon equipment in the environment, the identifying being based on the two or more different time instances of the satellite input images. The operations include generating, based on the analyzed feature data and the identified one or more objects, a prediction for an object among the one or more objects in the environment.

In some implementations, the object is an autonomous vehicle and the operations further include providing the prediction including at least one of (i) a trajectory, or (ii) a location at least one of (i) a system configured to retrieve autonomous vehicles, or (ii) a computing device configured to monitor retrieval of autonomous vehicles, in the environment.

In some implementations, the object is a piece of the hydrocarbon equipment and the operations further include providing the prediction including a status indicator for a piece of the hydrocarbon equipment in the environment to a system configured to monitor the environment, wherein the status indicator representing a health status of the piece of the hydrocarbon equipment.

In an aspect, one or more non-transitory computer readable media storing instructions to perform operations. The operations include receiving, by a computer system, satellite input images representing the environment captured by one or more satellites at different time instances, and receiving, by a communication network coupled to the computer system, environmental data that represents a state of the environment. The operations include determining at least one feature for extracting from the satellite input images and applying, based on determining the at least one feature and the state of the environment determined from the environmental data, one or more image processing functions to adjust pixels of the satellite input images for extraction of the at least one feature. The operations include analyzing, by at least one machine learning model, feature data including the at least one feature that is extracted from two or more different time instances of the satellite input images, and identifying, based on the analyzed feature data and by the at least one machine learning model, one or more objects from the hydrocarbon equipment in the environment, the identifying being based on the two or more different time instances of the satellite input images. The operations include generating, based on the analyzed feature data and the identified one or more objects, a prediction for an object among the one or more objects in the environment.

In some implementations, the object is an autonomous vehicle and the operations further include providing the prediction including at least one of (i) a trajectory, or (ii) a location at least one of (i) a system configured to retrieve autonomous vehicles, or (ii) a computing device configured to monitor retrieval of autonomous vehicles, in the environment.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 is a schematic view of an environment with remote sensors to image and track objects in the environment.

FIG. 2 illustrates an example system for generating output images and predictions objects in an environment based on remote sensing data.

FIG. 3A illustrates an example process for generating output images of the environment using machine learning models.

FIG. 3B illustrates an example process for training the machine learning models.

FIG. 4 is a diagram of an example data processing system.

FIG. 5 illustrates example hydrocarbon production operations.

### DETAILED DESCRIPTION

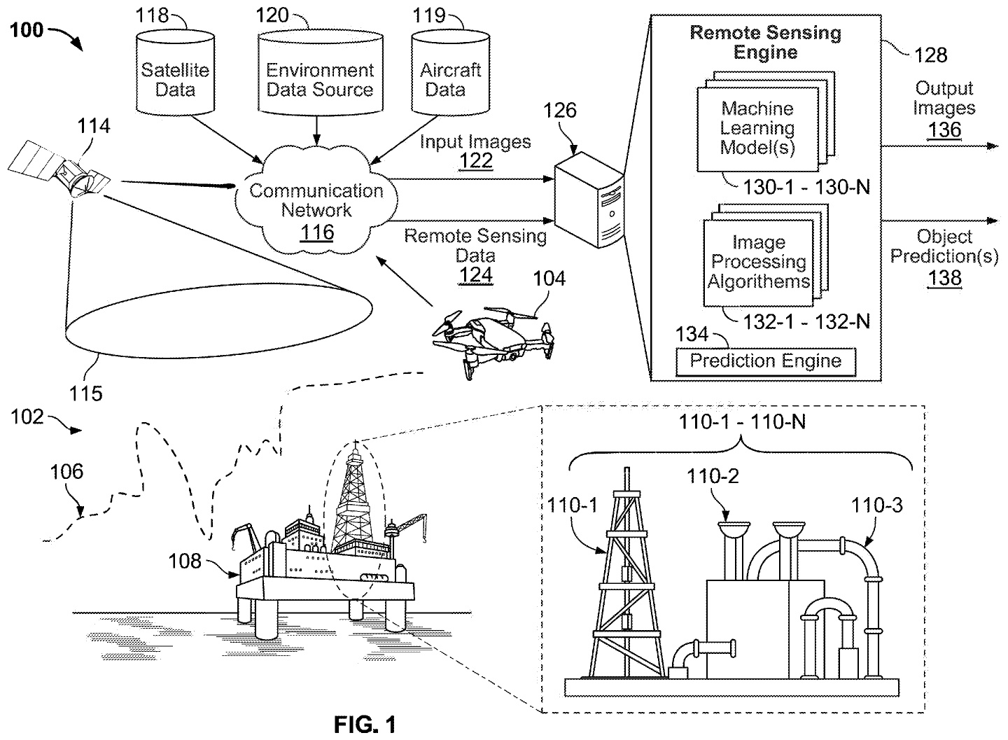

FIG. 1 is a schematic view 100 of an environment 102 with remote sensors configured to image and track objects in the environment. The environment 102 includes a platform 108 that extracts hydrocarbons (e.g., oil, natural gas) from underneath a surface of the ocean floor. The view 100 depicts remote sensors 104 and 106 as a satellite 114 and an unmanned aircraft 104 (e.g., an unmanned aerial vehicle, a drone) configured to monitor and capture input images 122 of the platform 108. The input images 122 and remote sensing data 124 can be provided to computing device 126 configured to generate output images 136 and object predictions 138 from data related to the environment 102.

Although a single satellite 114 and a single aircraft 104 are depicted in FIG. 1 as capturing sensor data from the environment 102, any number of remote sensors can be configured to capture sensor measurements of the platform 108. The unmanned aircraft 104 (also referred to as “aircraft 104”) is depicted as following a trajectory 106 at varying distances relative to the platform 108. The aircraft 104 can include an onboard cameras and sensors configured to capture images and sensor measurements, respectively, of the platform 108 and its surrounding environment.

The satellite 114 collects sensor data through a number of onboard sensors to capture measurements at different frequency bands of the electromagnetic spectrum, e.g., through energy reflected or refracted from the environment 102. For example, the satellite 114 can include infrared (IR) sensors to capture IR measurements (e.g., signals representing IR energy reflected or refracted) from the platform 108. In some implementations, the satellite 114 transmits a beam 115 to scan the environment and collects detection data from reflections and/or refractions associated with the transmitted beam 115. For example, the satellite 114 can include onboard radar transmitters and receivers to perform radar imaging (e.g., through synthetic aperture radar techniques) of the platform 108 and its surrounding environment.

As an example, one or both of the satellite 114 and the aircraft 104 can be configured to surveil and capture images of assets utilized by the platform 108 to perform resource extraction, storage, and transportation. The assets of the platform 108 include hydrocarbon equipment 110-1-110-N (collectively referred to as “equipment 110”). Examples of equipment 110 include drill 110-1, vent 110-2, and pipes 110-3, which are used by the platform 108 to extract and store hydrocarbons from underwater rock formations. In some implementations, the platform 108 is a platform positioned onto a subterranean formation to extract hydrocarbons from deposits at a depth below a surface layer of the subterranean formation.

The input images 122 obtained by the satellite 114 can include high-resolution images that are captured in near real-time. In some cases, the input images 122 are collected periodically (e.g., daily, a few times a day, hourly), continually, etc. to provide time-series images of the environment 102. In some implementations, the resolution of the input images 122 can be a high-definition resolution (e.g., 15 to 50 centimeters) map of the environment 102. The input images 122 can be referred to as satellite input images 122 when the images are captured by a satellite, e.g., satellite 114.

The view 100 depicts the satellite 114 and the aircraft 104 providing data to the computing device 126 by communication network 116. Satellite images from one or more satellites, including satellite 114, can be provided from servers and/or data storage devices that contain satellite data 118 and transmit the satellite data 118 to the computing device 126. In some implementations, the satellite data 118 includes historical, time-series data (e.g., additional images, sensor measurements) to the computing device 126. The view 100 also depicts environmental data sources 120 being provided to the computing device 126 by communication network 116, in which the environmental data sources 120 are another example type of data that can be stored in servers and/or data storage devices. Examples of the environmental data sources 120 can include weather data, air quality data, climate data (e.g., long-term weather data), geological data, and other types of data related characteristics of the environment 102 that can degrade the quality of images collected by satellite 114 and aircraft 104. Environmental data sources 120 can also include scientific earth and atmospheric data, e.g., atmospheric correction factors at different atmospheric layers.

The computing device 126 includes a remote sensing engine 128 configured to obtain and adjust the input images 122 to generate object predictions 138 about one or more objects in the environment 102. The remote sensing engine 128 includes machine learning models 130-1-130-N (collectively referred to as “machine learning models 130”), image processing algorithms 132-1-132-N (collectively referred to as “image processing algorithms 132”), and prediction engine 134. The machine learning models 130 are trained to identify patterns and key features in the remote sensing data 124 by analyzing measurements and data from the remote sensing data 124. The image processing algorithms 132 are configured to adjust pixel values and image features from the input images 122, applying adjustments to generate the output images 136 that have an improved image quality (e.g., removing defects in the images from effects of climate or weather factors for the environment) compared to the input images 122. The prediction engine 134 is configured to generate a prediction for one or more objects in the adjusted images, based on the adjusted pixel values and analyzed data. By improving image quality and accounting for remote sensing parameters, the remote sensing engine 128 improves the likelihood of a prediction for an object based on the adjusted output images 136 with high image quality, e.g., in contrast to generating predictions based on input images 122 with a low image quality.

The remote sensing engine 128 generates the object predictions 138 for objects in the environment 102, including predictions indicating a defect type and status for equipment 110 of the platform 108. An object prediction 138 can indicate a type of fault in the equipment 110 based on time-series satellite images, Examples of faults can include cracks and faults in pipes (e.g., pipe 110-3), poor exchange of gases in vents (e.g., vent 110-2), and degraded performance of drills (e.g., drill 110-1). The object predictions 138 can also provide a prediction for different levels of health for the equipment, including predictions indicating some equipment as healthy (e.g., within normal operational range), or a label indicating severity of the defects (e.g., low, medium, high, severe) indicating operation of the equipment outside of a normal operational range.

As another example, the remote sensing engine 128 generates the object prediction 138 of the trajectory 106 for aircraft 104. The object prediction 138 can include a prediction for an origin point (e.g., latitude, longitude, and elevation) for the aircraft 104, e.g., a location in the environment 102 in which the aircraft 104 was deployed, from the output images 136. In some implementations, the object prediction 138 can include a prediction of state information for the aircraft 104, including position, velocity, and acceleration of the aircraft 104 along the trajectory 106. The object prediction 138 can also include angular measurements (e.g., roll, pitch, and yaw) of the aircraft 104 for the trajectory 106. In some implementations, the object prediction 138 can include predictions for multiple trajectories that are possible for the aircraft 104 based on structural features of the environment 102 and parameters related to the aircraft 104, e.g., battery life and physical constraints. The constraints can include statistical values for speed, elevation, and other motional characteristics of the aircraft 104.

The object predictions 138 generated by the remote sensing engine 128 provide status monitoring and fault detection of the equipment 110 for the platform 108. By generating a prediction indicating a type of fault, corrective actions such as replacing or repairing the equipment can be performed before the equipment 110 experiences operative failure, e.g., pipes bursting, drills malfunctioning, poor collection or discharging of gases from the vents. The object predictions 138 also provide that trajectories estimated for aircraft 104 accurately track the location of the aircraft 104 in case of operational failure of the aircraft 104, e.g., lost or failed vehicles. For example, an aircraft 104 can become defective when a battery level is too low (e.g., below a threshold value) that causes the aircraft 104 to cease motion or stray from a planned trajectory. In some cases, the aircraft 104 can become defective due to a collision with another object in the environment 102 (e.g., another vehicle in the environment 102, equipment in the platform 108).

The remote sensing engine 128 leverages additional context provided by the environmental data sources 120 to identify degradations in quality of the images collected by the remote sensors (e.g., satellite images captured by satellite 114, aerials images captured by the aircraft 104). For example, the environmental data sources 120 can include weather patterns observed for the environment 102 during a time period in which the satellite images, e.g., the input images 122, of the environment 102 were captured. Weather patterns from different types of precipitation (e.g., rain, snow, hail) and visibility conditions (e.g., fog, mist) can result in degraded features captured in the pixels (e.g., pixel values) of the input images 122. As another example, the environmental data 120 can be atmospheric data that includes correction factors for scattering and absorption effects of the atmosphere, e.g., to correct reflectance values from pixels in the input images 122 collected by satellite 114.

The remote sensing engine 128 includes the machine learning models 130 to identify patterns and key features of the environment 102 based on the remote sensing data 124. The remote sensing 128 obtains remote sensing data 124 for training the machine learning models 130 using sets of atmospheric data, weather data, and other types of measurements for the environment 102. The remote sensing data 124 can include satellite data 118, environmental data sources 120, and aircraft data 119, e.g., data captured by different remote sensors. For example, satellite data 118 can include sensor measurements, images, and satellite navigation information (e.g., position, velocity, and acceleration information about the satellite). Based on the additional context provided from data sources such as the satellite data 118, aircraft data 119, and the environmental data sources 120, the machine learning models 130 generate key features and patterns as an input for prediction engine 134 to generate predictions of one or more objects from the adjusted images.

In some implementations, aircraft data 119 such as state information (e.g., local position, acceleration, speed), planned trajectories, battery levels, and other types of data can be provided to the remote sensing engine 128. Defects in the satellite images (e.g., input images 122) associated with dynamics of the aircraft 104 can be corrected to enhance the quality of feature data for the aircraft 104 in the image.

In some implementations, the satellite data 118 can be obtained from servers associated to satellite data providers (e.g., government agencies, commercial satellite providers, satellite data subscription services).

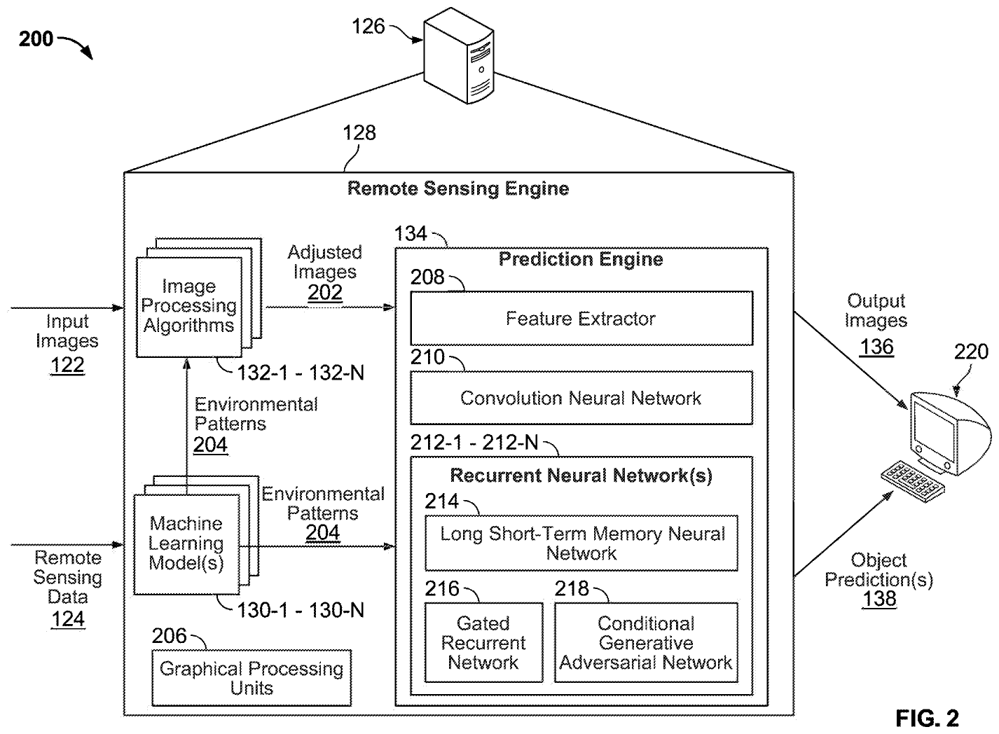

FIG. 2 illustrates an example system 200 for generating output images and predictions of one or more objects in the environment 102 based on remote sensing images and data. The system 200 includes the computing device 126 receives the input images 122 and the remote sensing data 124 to generate the outputs of the system 200, e.g., output images 136 and object predictions 138. The system 200 depicts the computing device 126 and the components of the remote sensing engine 128 of FIG. 1, described above.

The machine learning models 130 obtain and analyze the remote sensing data 124 to identify environmental patterns 204, which include atmospheric and weather conditions. For example, the environmental patterns 204 can indicate the presence of atmospheric interference and precipitation (e.g., rain, snow, hail) that affect image quality of input images 122 collected by remote sensors. By generating environmental patterns 204, the machine learning models 130 provide that improvement from applying the image processing algorithms 132 result in an improved image quality, for improve the accuracy of a prediction generated by the prediction engine 134. The machine learning models 130 can also be configured to perform object detection for the environment 102 based on the features of the satellite input images 122.

The image processing algorithms 132 applied by the remote sensing engine 128 include adjustments to pixel values of the input images 122 to generate adjusted images 202. An example adjustment performed by the image processing algorithms 132 includes applying an adjustment (e.g., increasing, decreasing) pixel values of particular colors in pixels of the input images. Another example adjustment includes adjusting the brightness, contrast, or some combination herein, of the input images 122 to generate the adjusted images 202. In some implementations, the image processing algorithms 132 include de-noising, enhancement, and alignment of pixels in the input images 122. The image processing algorithms 132 compensate a degradation in image quality of the input images 122 collected by remote sensors, by correcting for the degradation from the environmental patterns 204. For example, the image processing algorithms 132 can sharpen images (e.g., adjusting contrast of pixel values) to compensate for fog, mist, and other types of precipitation indicated by the environmental patterns 204 that can produce a blur effect in the input images. As another example, the environmental patterns 204 can include climate patterns (e.g., El Niño effect, La Niña effect) which indicate types of seasonal impacts to the environment 102, thereby affecting the quality of satellite images and other types of remote sensing images captured.

In some implementations, the remote sensing engine 128 includes graphical processing units (GPUs) 206 that can be leveraged for applying the image processing algorithms 132, training the machine learning models 130, generating predictions from the prediction 134, or some combination thereof. For example, a subset of the GPUs 206 can be tailored to perform a particular type of pixel value adjustment to the input images 122 to generate the adjusted images 202. As another example, another subset of the GPUs 206 can be configured to identify climate patterns from environmental data sources, e.g., through remote sensing data 124.

The prediction engine 134 of the remote sensing engine 128 utilizes the adjusted images 202 and environmental patterns 204 to generate the object predictions of one or more images in the environment 102. In particular, the prediction engine 134 includes a feature extractor 208, a convolutional neural network (CNN) 210, and recurrent neural networks (RNNs) 212-1-212-N (collectively referred to as “recurring neural networks 212” or “RNNs 212”). The feature extractor 208 extracts feature data from the adjusted images 202, e.g., based on pixel values of the adjusted images. The prediction engine 134 can be configured to perform object detection from the extracted feature data to identify locations in the adjusted images 202 associated with the detection of one or more objects. In some implementations, the prediction engine 134 performs a comparison of feature data across multiple adjusted images 202 of the environment 102. By comparing the differences in the feature data, the prediction engine 134 can discern stationary objects such as the platform 108 from moving objects, such as the equipment 110, the aircraft 104, and other moving objects in the environment.

The prediction engine 134 includes the CNN 210 to collect a sequence of time-varying adjusted images 202 of the environment 102 and filter a subset of feature data corresponding to the adjusted images 202. In some implementations, the CNN 210 is configured to adjust pixel values across the sequence of time-varying adjusted images 202. For example, this can include applying a subset of the same image processing algorithms 132 to a portion of pixels associated with an object for multiple images in the adjusted images 202. In some implementations, the image processing algorithms 132 can also include edge detection to adjust image brightness or illumination values, thereby improving the perception of color data in features from the satellite images.

The prediction engine 134 includes RNNs 212 configured to perform pattern detection for a sequence of time-varying adjusted images 202 of the environment 102. The pattern detection can include detecting patterns of features in the pixel data of the adjusted images 202 that can be associated to a type of defect for the object. In some cases, the pattern can be associated with a particular maneuver or trajectory of an object in the environment depicted in the adjusted images 202. In some implementations, the CNN 210 can be coupled to the RNNs 212 to optimize an output of the prediction engine, e.g., an object prediction 138 with an associated probability exceeding a threshold value. The CNN 210 can be configured to analyze object features from subsets of pixels relative to surrounding pixels in the image. The RNNs 212 can be configured to analyze spatial and temporal features from two or more images at different time instances. The combination of the CNN 210 and the RNNs 212 can provide an improvement in image resolution and anomaly detection from the improved image resolution.

The RNNs 212 include one or both of a long short-term memory network (LSTM) 214 and gated recurrent network 216. The gated recurrent network 216 can be configured to identify portions of pixels or feature data in the adjusted images 202 that decay over time for the sequence of images. For example, the gated recurrent network 216 can account for gradient clipping in the RNNs 212 but can also provide steeper gates or improved optimization of the RNNs 212. In some implementations, the RNNs 212 is a single recurrent neural network. In some implementations, the RNNs 212 include a single recurrent neural network with multiple layers, each layer including a respective recurrent neural network, e.g., a stacked recurrent neural network. The LSTM 214 can be coupled to the RNNs 212 to handle vanishing gradients and improve memory of the RNNs 212. By doing so, the LSTM 214 improves the analysis of spatial and/or temporal features performed by the RNNs 212.

The prediction engine 134 can generate the object prediction 138 using the machine learning models 130 and the neural networks of the prediction engine 134 to fit historical data of the environment patterns 204 to the observations captured by the adjusted images. The prediction engine 134 can be configured to leverage ensemble learning methods, e.g., adaptive boosting, decision trees, support vector machines (SVMs), or any other supervised learning algorithm to generate object prediction 138.

In some implementations, the CNN 210 can be configured to strategy the adjusted images 202 into different abstraction levels based on topology of the adjusted images. The RNNs 212 can be configured to detect areas of interest in the adjusted images at each abstraction level and detect deformations in the pixels associated to different objects in the images.

In some implementations, the prediction engine 134 is configured to identify objects from the adjusted images 202 by comparing the size of the object in pixels and structures of the features data for the object from the pixels. In some implementations, the machine learning models 130 are trained on different classes corresponding to different types of objects or equipment in the environment 102. For example, the machine learning models 130 can generate a prediction for object classification that is based on the size and shape of pixels associated to a particular object class.

In some implementations, the prediction engine 134 is configured to downsample the input images 122 to multiple image datasets at resolutions smaller than an original resolution of the input images 122. The prediction engine 134 can then apply a deep spatiotemporal sequence prediction technique to generate multi-scale prediction images, each set of multi-scale images having different resolutions. The deep spatiotemporal sequence prediction technique includes a time-series analysis of the satellite images (e.g., input images, adjusted or “enhanced” images) to detect an operation status (e.g., a prediction) for equipment in the images. Each set of multi-scale images can have an individual prediction that can be fused by the prediction engine 134 through a conditional generative adversarial network 218 (also referred to as “cGAN 218”) to generate output images 136 with corresponding target object predictions 138.

In some implementations, the cGAN 218 can be configured with training examples that include annotations of objects in satellite images. The cGAN 218 performs image augmentation to generate additional training examples from the satellite times. The cGAN 218 can also determine image location for identified objects by analyzing portions of pixels indicating a position of an object in the image. Different positions for objects in the image can be tracked across different time instances to determine trajectories or changing status indicators of the objects. The cGAN 218 can be configured to reconstruct images from adjusted feature data to generated the adjusted satellite images. In some implementations, the cGAN 218 performs dimensionality reduction or segmentation of features in the satellite data to improve predictions by reducing the effects of defects in higher dimensions, e.g., removing redundant features and reducing training time.

The remote sensing engine 128 can perform a variety of training techniques to adjust images, including supervised and unsupervised learning techniques. In some implementations, the remote sensing engine 128 performs hybrid-learning techniques to improve accuracy of generating predictions of objects and track objects in the environment 102. The remote sensing engine 128 can adjust one or more weights or parameters for the machine learning models 130 and the neural networks of the prediction engine 134. By doing so, the remote sensing engine 128 improves its accuracy generating object predictions 138. In some implementations, models and networks of the remote sensing engine 128 include one or more fully or partially connected layers. Each of the layers can include one or more parameter values indicating an output of the layers.

In some implementations, the remote sensing engine 128 can be configured to provide the output images 136 and the object predictions 138 to a device 220. The device 220 can be part of a system configured to monitor the status of hydrocarbon equipment in the environment 102, among other environments having respective hydrocarbon equipment. The device 220 can be configured by the remote sensing engine 128 to adjust operation of the equipment 110. For example, the device 220 can cause the equipment to scale back production operations or cease operation of equipment for hydrocarbon production. In some implementations, the device 220 can be part of a system configured to retrieve or monitor retrieval of autonomous vehicles in the environment 102. As an example, the device 220 can be configured to retrieve the autonomous vehicle based on a predicted location of the autonomous vehicle in the environment 102.

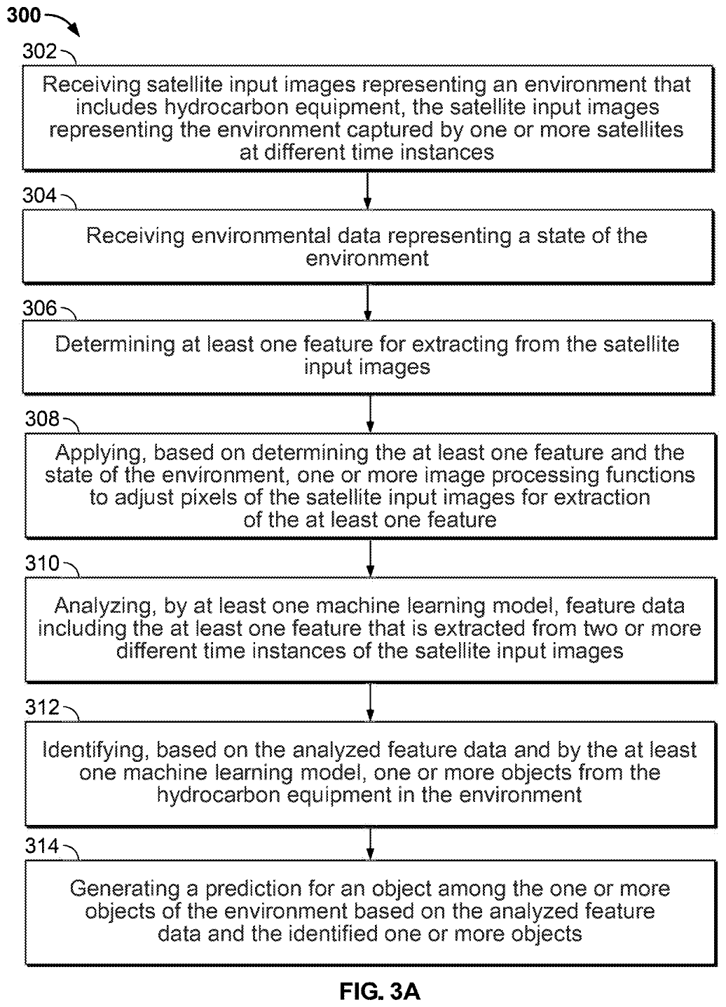

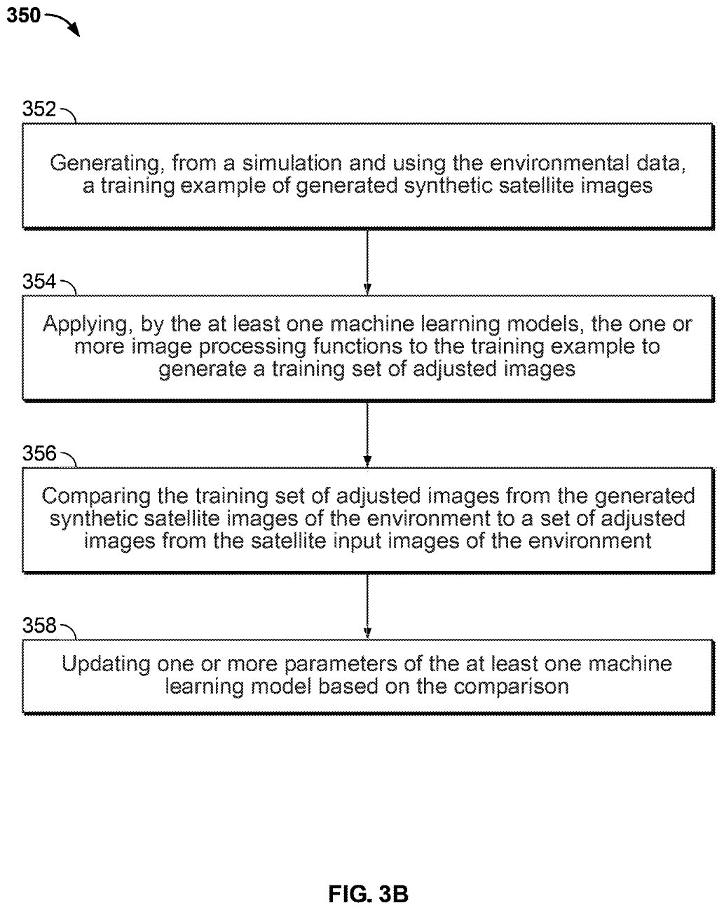

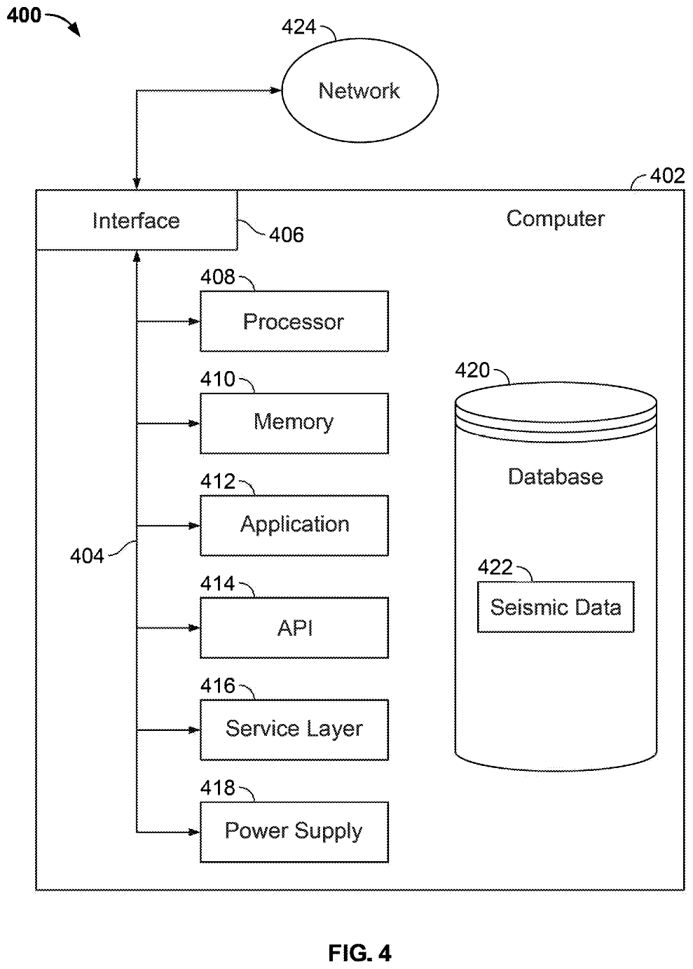

FIG. 3A illustrates an example process 300 for generating output images 136 and object predictions 138 of the environment 102 using machine learning models 130. In some implementations, the process 300 is performed by a data processing system that includes the remote sensing engine 128. Such a data processing system 400 is subsequently described in more detail in relation to FIG. 4.

In step 302, the data processing system receives the satellite input images (e.g., input images 122) representing an environment (e.g., environment 100) that includes hydrocarbon equipment (e.g., equipment 110), the satellite input images representing the environment captured by one or more satellites (e.g., satellite 114) of the environment at different time instances.

In step 304, the data processing system receives environmental data by a communication network coupled data processing system, e.g., from one or more environmental data sources 120. The environmental data represents a state of the environment, e.g., weather data, climate data, infrared data, historical data, radiometric data, geometric data, or some combination thereof.

In step 306, the data processing system determines at least one feature for extracting from the satellite input images. Examples of features can include characteristics of hydrocarbon equipment, autonomous vehicles, and other parts of the environment 102.

In step 308, the data processing system applies one or more image processing functions based on determining the at least one feature and the state of the environment, for extraction of the at least one feature. The image processing functions can include denoising, filtering, contrast adjustment, position alignment, downsampling, up-sampling, edge enhancement, of the pixels in the input images. The processing for the pixels can include modifications to pixel attributes to account for defects in the satellite images from environmental data. In some implementations, the data processing system is configured to generate a set of adjusted images of the environment from the satellite input images by applying the image processing algorithms to the satellite input images.

In step 310, at least one machine learning model of the data processing system analyzes feature data extracted from two or more different time instances of the satellite input images, e.g., by extracting feature data from adjusted pixels of the satellite input images or pixels of adjusted images. In some implementations, the machine learning model can be trained using the environmental data to identify image processing functions to adjust pixels of the input images. The machine learning model(s) can be trained to determine the image processing functions based on training examples for different sets of satellite data of an environment, the environmental data for the environment, and ground truth observations of hydrocarbon equipment and/or autonomous vehicles (e.g., aircraft) in the environment.

A model from the machine learning models can include a neural network configured to filter sets of features across different time instances of the input images, e.g., accounting for defects in spatial and/or temporal domains of the images.

In some implementations, the data processing system is configured to downsample input images at a first resolution to multiple sets of images at image resolutions at different resolutions lower than the first resolution. The data processing system generates a first set of predictions for the multiple sets of images through the machine learning models. The data processing system includes a conditional generative adversarial network configured to combine the first set of predictions with a second set of predictions generated from the input images at the first resolution. The second set of predictions are generated by the conditional generative adversarial network at second resolution greater than the first resolution.

In some implementations, a convolutional neural network (CNN) of the machine learning model is configured to generate subsets of the adjusted images. Each subset of the adjusted images shares topological features in the feature data determined by the convolutional neural network. One or more recurrent neural networks (RNN) of the machine learning models are configured to determine patterns over the different time instances from the feature data for the subsets of the adjusted images, e.g., including a generated set of adjusted images. The data processing system is configured to identify one or more objects in the environment based on the one or more patterns and generate the prediction based on the one or more patterns for the one or more objects in the environment from the feature data.

In step 312, the data processing system identifies one or more objects from the hydrocarbon equipment the environment based on the analyzed feature data and by machine learning model. In some implementations, identifying the one or more objects in the environment includes determining a difference in size and structures of pixels from the adjusted images, e.g., an image with image processed functions applied. In some implementations, identifying the one or more objects in the environment includes determining a difference in positions of pixels from the adjusted images.

In step 314, the data processing system generates a prediction for an object among the one or more objects of the environment based on the analyzed feature data. In some implementations, an object from the one or more objects in the environment an autonomous vehicle configured to capture data of the hydrocarbon equipment in the environment. In some implementations, the prediction for the object from the hydrocarbon equipment includes a status indicator for a piece of hydrocarbon equipment. The status indicator can include a label representing a health status of the hydrocarbon equipment (e.g., “defective”, “healthy”). In some implementations, the data processing system further provides the prediction includes the status indicator for the piece of hydrocarbon equipment in the environment to a system configured to monitor the environment.

In some implementations, the prediction is a trajectory, position, state information, or some combination thereof, for an autonomous vehicle. The prediction can be provided to at least one of (i) a system configured to retrieve autonomous vehicles, or (ii) a computing device configured to monitor retrieval of autonomous vehicles. A location from the prediction can include coordinates in the environment that correspond to the autonomous vehicle. The location can be transmitted to a device configured to assist in the retrieval of autonomous vehicles in the environment.

FIG. 3B illustrates an example process 350 for training the machine learning models 130. In some implementations, the process 300 is performed by a data processing system. Such a data processing system 400 is subsequently described in more detail in relation to FIG. 4.

In step 352, the data processing system generates a training example of synthetic satellite images using a simulation configured to generate synthetic satellite images of the environment based on the environmental data.

In step 354, the machine learning models are configured to apply the image processing functions to the training example to generate a training set of adjusted images. The training example provides pattern detection of defects that are determined from the environmental data to the synthetic data and apply image processing algorithms, e.g., contrast enhancement, to correct for the defects.

In step 356, the data processing system compares the training set of adjusted images from the generated synthetic satellite images of the environment to a set of adjusted images generated from the satellite input images of the environment.

In step 358, the data processing system updates one or more parameters of the machine learning models based on the comparison of the training set of adjusted images and the adjusted images.

FIG. 4 is a block diagram of an example data processing system 400 used to provide computational functionalities associated with described algorithms, methods, functions, processes, flows, and procedures described in the present disclosure, according to some implementations of the present disclosure. The illustrated computer 402 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI).

The computer 402 can serve in a role as a client, a network component, a server, a database, a persistency, or components of a computer system for performing the subject matter described in the present disclosure. The illustrated computer 402 is communicably coupled with a network 424. In some implementations, one or more components of the computer 402 can be configured to operate within different environments, including cloud-computing-based environments, local environments, global environments, and combinations of environments.

At a high level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 424 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 404. In some implementations, any or all of the components of the computer 402, including hardware or software components, can interface with each other or the interface 406 (or a combination of both), over the system bus 404. Interfaces can use an application programming interface (API) 414, a service layer 416, or a combination of the API 414 and service layer 416. The API 414 can include specifications for routines, data structures, and object classes. The API 414 can be either computer-language independent or dependent. The API 414 can refer to a complete interface, a single function, or a set of APIs.

The service layer 416 can provide software services to the computer 402 and other components (whether illustrated or not) that are communicably coupled to the computer 402. The functionality of the computer 402 can be accessible for all service consumers using this service layer. Software services, such as those provided by the service layer 416, can provide reusable, defined functionalities through a defined interface. For example, the interface can be software written in JAVA, C++, or a language providing data in extensible markup language (XML) format. While illustrated as an integrated component of the computer 402, in alternative implementations, the API 414 or the service layer 416 can be stand-alone components in relation to other components of the computer 402 and other components communicably coupled to the computer 402. Moreover, any or all parts of the API 414 or the service layer 416 can be implemented as child or sub-modules of another software module, enterprise application, or hardware module without departing from the scope of the present disclosure.

The computer 402 includes an interface 406. Although illustrated as a single interface 406 in FIG. 4, two or more interfaces 406 can be used according to particular needs, desires, or particular implementations of the computer 402 and the described functionality. The interface 406 can be used by the computer 402 for communicating with other systems that are connected to the network 424 (whether illustrated or not) in a distributed environment. Generally, the interface 406 can include, or be implemented using, logic encoded in software or hardware (or a combination of software and hardware) operable to communicate with the network 424. More specifically, the interface 406 can include software supporting one or more communication protocols associated with communications. As such, the network 424 or the hardware of the interface can be operable to communicate physical signals within and outside of the illustrated computer 402.

The computer 402 includes a processor 408. Although illustrated as a single processor 408 in FIG. 4, two or more processors 408 can be used according to particular needs, desires, or particular implementations of the computer 402 and the described functionality. Generally, the processor 408 can execute instructions and can manipulate data to perform the operations of the computer 402, including operations using algorithms, methods, functions, processes, flows, and procedures as described in the present disclosure.

The computer 402 also includes a database 420 that can hold data (for example, seismic data 422) for the computer 402 and other components connected to the network 424 (whether illustrated or not). For example, database 420 can be an in-memory, conventional, or a database storing data consistent with the present disclosure. In some implementations, database 420 can be a combination of two or more different database types (for example, hybrid in-memory and conventional databases) according to particular needs, desires, or particular implementations of the computer 402 and the described functionality. Although illustrated as a single database 420 in FIG. 4, two or more databases (of the same, different, or combination of types) can be used according to particular needs, desires, or particular implementations of the computer 402 and the described functionality. While database 420 is illustrated as an internal component of the computer 402, in alternative implementations, database 420 can be external to the computer 402.

The computer 402 also includes a memory 410 that can hold data for the computer 402 or a combination of components connected to the network 424 (whether illustrated or not). Memory 410 can store any data consistent with the present disclosure. In some implementations, memory 410 can be a combination of two or more different types of memory (for example, a combination of semiconductor and magnetic storage) according to particular needs, desires, or particular implementations of the computer 402 and the described functionality. Although illustrated as a single memory 410 in FIG. 4, two or more memories 410 (of the same, different, or combination of types) can be used according to particular needs, desires, or particular implementations of the computer 402 and the described functionality. While memory 410 is illustrated as an internal component of the computer 402, in alternative implementations, memory 410 can be external to the computer 402.

The application 412 can be an algorithmic software engine providing functionality according to particular needs, desires, or particular implementations of the computer 402 and the described functionality. For example, application 412 can serve as one or more components, modules, or applications. Further, although illustrated as a single application 412, the application 412 can be implemented as multiple applications 412 on the computer 402. In addition, although illustrated as internal to the computer 402, in alternative implementations, the application 412 can be external to the computer 402.

The computer 402 can also include a power supply 418. The power supply 418 can include a rechargeable or non-rechargeable battery that can be configured to be either user-or non-user-replaceable. In some implementations, the power supply 418 can include power-conversion and management circuits, including recharging, standby, and power management functionalities. In some implementations, the power-supply 418 can include a power plug to allow the computer 402 to be plugged into a wall socket or a power source to, for example, power the computer 402 or recharge a rechargeable battery.

There can be any number of computers 402 associated with, or external to, a computer system containing computer 402, with each computer 402 communicating over network 424. Further, the terms “client,” “user,” and other appropriate terminology can be used interchangeably, as appropriate, without departing from the scope of the present disclosure. Moreover, the present disclosure contemplates that many users can use one computer 402 and one user can use multiple computers 402.

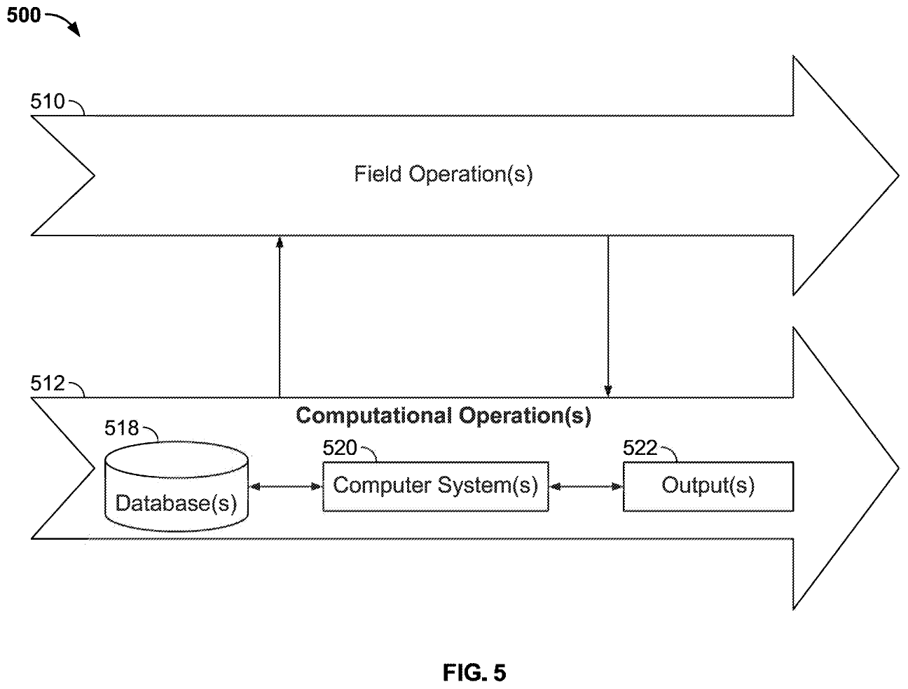

FIG. 5 illustrates hydrocarbon production operations 500 that include both one or more field operations 510 and one or more computational operations 512, which exchange information and control exploration for the production of hydrocarbons. In some implementations, outputs of techniques of the present disclosure can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, it will be understood that various modifications may be made without departing from the scope of the data processing system described herein. Accordingly, other embodiments are within the scope of the following claims.

What is claimed is:

1. A method for analyzing and correcting satellite images representing an environment that includes hydrocarbon equipment, the method comprising:
receiving, by a computer system, satellite input images representing the environment captured by one or more satellites at different time instances;
receiving, by a communication network coupled to the computer system, environmental data that represents a state of the environment;
determining at least one feature for extracting from the satellite input images;
applying, based on determining the at least one feature and the state of the environment determined from the environmental data, one or more image processing functions to adjust pixels of the satellite input images for extraction of the at least one feature;
analyzing, by at least one machine learning model, feature data including the at least one feature that is extracted from two or more different time instances of the satellite input images;
identifying, based on the analyzed feature data and by the at least one machine learning model, one or more objects from the hydrocarbon equipment in the environment, the identifying being based on the two or more different time instances of the satellite input images; and
generating, based on the analyzed feature data and the identified one or more objects, a prediction for an object among the one or more objects in the environment.

2. The method of claim 1, wherein the at least one machine learning model is trained to generate predictions of objects from the hydrocarbon equipment in the environment, the method comprising:
generating, by a simulation configured to generate synthetic satellite images of the environment and using the environmental data, a training example comprising the generated synthetic satellite images;
applying, by the at least one machine learning, the one or more image processing functions to the training example to generate a training set of adjusted images, wherein an adjusted image from the training set of adjusted images comprises pixels adjusted by the one or more image processing functions;
comparing the training set of adjusted images from the generated synthetic satellite images of the environment to a set of adjusted images generated from the satellite input images of the environment; and
updating, based on a comparison of the training set of adjusted images and the set of adjusted images, one or more parameters of the at least one machine learning model.

3. The method of claim 1, further comprising:
determining, based on the environmental data, one or more environmental effects from the environment that affect a quality of the satellite input images; and
removing, the one or more environmental effects from the satellite input images.

4. The method of claim 1, wherein the object is an autonomous vehicle and the prediction for the object comprises at least one of (i) a trajectory, or (ii) a location, for the autonomous vehicle.

5. The method of claim 4, further comprising:
providing the prediction comprising at least one of (i) the trajectory, or (ii) the location at least one of (i) a system configured to retrieve autonomous vehicles, or (ii) a computing device configured to monitor retrieval of autonomous vehicles, in the environment.

6. The method of claim 1, wherein the object is a piece of the hydrocarbon equipment, and the prediction comprises a status indicator for the piece of the hydrocarbon equipment, the status indicator representing a health status of the piece of the hydrocarbon equipment.

7. The method of claim 6, further comprising:
providing the prediction comprising the status indicator for the piece of the hydrocarbon equipment in the environment to a system configured to monitor the environment.

8. The method of claim 1, wherein identifying the one or more objects in the environment comprises determining a difference in (i) size and structures, or (ii) positions, of pixels from the analyzed feature data for the satellite input images.

9. The method of claim 1, wherein analyzing the feature data by the at least one machine learning model comprises:
generating, by a convolutional neural network (CNN) of the at least one machine learning model, subsets of the satellite input images, wherein a subset of the satellite input images share a plurality of topological features in the feature data determined by the convolutional neural network;
determining, by one or more recurrent neural networks (RNN) of the at least one machine learning model, one or more patterns over the different time instances from the feature data for the subsets of the satellite input images;
identifying one or more objects in the environment based on the one or more patterns; and
generating the prediction based on the one or more patterns for the one or more objects in the environment from the feature data.

10. The method of claim 1, further comprising:
downsampling the satellite input images at a first resolution to a plurality of image datasets at a plurality of resolutions, wherein each resolution in the plurality of resolutions is lower than the first resolution,
generating a first set of predictions for the plurality of image datasets; and
combining, by a conditional generative adversarial network of the at least one machine learning model, the first set of predictions to a second set of predictions generated from the input images at the first resolution, wherein the second set of predictions are generated at second resolution greater than the first resolution.

11. The method of claim 1, wherein the one or more image processing functions comprises at least one of (i) denoising, (ii) filtering, (iii) contrast adjustment, (iv) position alignment, (v) downsampling, (vi) up-sampling, (vii) edge enhancement, of the pixels in the satellite input images.

12. The method of claim 1, wherein the environmental data comprises at least one of (i) infrared data, (ii) simulation data, (iii) weather conditions, (iv) ground truth measurements, (v) historical data, (vi) geological data, or (vii) climate data, of the environment.

13. A system for analyzing and correcting satellite images representing an environment that includes hydrocarbon equipment, the system comprising:
at least one processor; and
a memory storing instructions that, when executed by the at least one processor, cause the at least one processor to perform operations comprising:
receiving, by a computer system, satellite input images representing the environment captured by one or more satellites at different time instances;
receiving, by a communication network coupled to the computer system, environmental data that represents a state of the environment;
determining at least one feature for extracting from the satellite input images;
applying, based on determining the at least one feature and the state of the environment determined from the environmental data, one or more image processing functions to adjust pixels of the satellite input images for extraction of the at least one feature;
analyzing, by at least one machine learning model, feature data including the at least one feature that is extracted from two or more different time instances of the satellite input images;
identifying, based on the analyzed feature data and by the at least one machine learning model, one or more objects from the hydrocarbon equipment in the environment, the identifying being based on the two or more different time instances of the satellite input images; and
generating, based on the analyzed feature data and the identified one or more objects, a prediction for an object among the one or more objects in the environment.

14. The system of claim 13, wherein the at least one machine learning model is trained to generate predictions of objects from the hydrocarbon equipment in the environment, the operations further comprising:
generating, by a simulation configured to generate synthetic satellite images of the environment and using the environmental data, a training example comprising the generated synthetic satellite images;
applying, by the at least one machine learning, the one or more image processing functions to the training example to generate a training set of adjusted images, wherein an adjusted image from the training set of adjusted images comprises pixels adjusted by the one or more image processing functions;
comparing the training set of adjusted images from the generated synthetic satellite images of the environment to a set of adjusted images generated from the satellite input images of the environment; and
updating, based on a comparison of the training set of adjusted images and the set of adjusted images, one or more parameters of the at least one machine learning model.

15. The system of claim 13, wherein the object is an autonomous vehicle and the operations further comprise:
providing the prediction comprising at least one of (i) a trajectory, or (ii) a location at least one of (i) a system configured to retrieve autonomous vehicles, or (ii) a computing device configured to monitor retrieval of autonomous vehicles, in the environment.

16. The system of claim 13, wherein the object is a piece of the hydrocarbon equipment and the operations further comprise:
providing the prediction comprising a status indicator for a piece of the hydrocarbon equipment in the environment to a system configured to monitor the environment, wherein the status indicator representing a health status of the piece of the hydrocarbon equipment.

17. One or more non-transitory computer readable media storing instructions to analyze and correct satellite images representing an environment that includes hydrocarbon equipment, the instructions, when executed by at least one processor, configured to cause the at least one processor to perform operations comprising:
receiving, by a computer system, satellite input images representing the environment captured by one or more satellites at different time instances;
receiving, by a communication network coupled to the computer system, environmental data that represents a state of the environment;
determining at least one feature for extracting from the satellite input images;
applying, based on determining the at least one feature and the state of the environment determined from the environmental data, one or more image processing functions to adjust pixels of the satellite input images for extraction of the at least one feature;
analyzing, by at least one machine learning model, feature data including the at least one feature that is extracted from two or more different time instances of the satellite input images;
identifying, based on the analyzed feature data and by the at least one machine learning model, one or more objects from the hydrocarbon equipment in the environment, the identifying being based on the two or more different time instances of the satellite input images; and
generating, based on the analyzed feature data and the identified one or more objects, a prediction for an object among the one or more objects in the environment.

18. The one or more non-transitory computer readable media of claim 17, wherein the at least one machine learning model is trained to generate predictions of objects from the hydrocarbon equipment in the environment, the operations further comprising:
generating, by a simulation configured to generate synthetic satellite images of the environment and using the environmental data, a training example comprising the generated synthetic satellite images;
applying, by the at least one machine learning, the one or more image processing functions to the training example to generate a training set of adjusted images, wherein an adjusted image from the training set of adjusted images comprises pixels adjusted by the one or more image processing functions;
comparing the training set of adjusted images from the generated synthetic satellite images of the environment to a set of adjusted images generated from the satellite input images of the environment; and
updating, based on a comparison of the training set of adjusted images and the set of adjusted images, one or more parameters of the at least one machine learning model.

19. The one or more non-transitory computer readable media of claim 17, wherein the object is an autonomous vehicle, and the operations further comprise:
providing the prediction comprising at least one of (i) a trajectory, or (ii) a location at least one of (i) a system configured to retrieve autonomous vehicles, or (ii) a computing device configured to monitor retrieval of autonomous vehicles, in the environment.

20. The one or more non-transitory computer readable media of claim 17 wherein the object is a piece of the hydrocarbon equipment and the operations further comprise:
providing the prediction comprising a status indicator for a piece of the hydrocarbon equipment in the environment to a system configured to monitor the environment, wherein the status indicator representing a health status of the piece of the hydrocarbon equipment.
